(19) United States
(12) Patent Application Publication
(10) Pub. No.: US 2005/0263970 A1
(43) Pub. Date: Dec. 1, 2005

(54) Temporary trash container

(76) Inventor: Robin R. Foster-Hentz, Staunton, IL (US)

Correspondence Address: CHARLES C. MCCLOSKEY, 763 S. NEW BALLAS ROAD STE. 170, ST. LOUIS, MO, 63141, US

(21) Appl. No.: 11/118,983

(22) Filed: Apr. 29, 2005

Related U.S. Application Data
(60) Provisional application No. 60/575,061, filed on May 27, 2004.

(51) Int. Cl. B62B 1/00

(52) U.S. Cl. 280/47.26

(57) ABSTRACT

The temporary trash container generally tastefully decorates a container with a hinged lid that stores bags. Residents place bags in the container as desired and then the garbage men retrieve the trash bags. The container can remain in one location indefinitely. The container has a generally rectangular box shape with a front panel, a left side panel, a right side panel, a rear panel, a lid hinged to the rear panel and to a door included with the front panel, and a bottom panel. The present invention has wheels and handles for movement of the container and placement of flower boxes as desired.

### CROSS-REFERENCE TO RELATED APPLICATIONS

This non-provisional application claims the benefit of priority to the provisional application Ser. No. 60/575,061, filed May 27, 2004 by the same inventor. The above noted application is incorporated herein by reference.

### BACKGROUND OF THE INVENTION

The temporary trash container relates generally to storage devices, and more specifically to waste receptacles.

Through living, people produce trash in many forms industrially, commercially, and residentially. In a residential setting, people produce food scraps, paper, other packaging, and debris from domestic projects. People have to dispose of their trash for sanitation and aesthetic reasons. People dislike the odors and appearance of trash and containers thereof.

In separate houses, subdivisions, condominiums, and apartments, trash is usually picked up on a regular basis. Some residential settings use dumpsters for residents to place trash at anytime and waste haulers to remove at any time. Some view dumpsters as unsightly. Other residential settings use trash cans placed at the curb by residents on a designated day. Depending on weather, empty trash cans may roll or blow around a neighborhood. And in other residential settings, residents place the bags of trash alone at their curb. Trash bags appear unsightly and may be opened by animals. Each method of temporary trash storage prior to pick up has its advantages and disadvantages.

### DESCRIPTION OF THE PRIOR ART

Trash containers have proliferated into numerous varieties. Industrial sites have open and closed dumpsters of varying capacity and with or without compactors. Toning down from the industrial, residential sites also have various trash containers.

Large residential and communal areas have dumpsters located at a mutually convenient place for residents and trash haulers. The residents can place trash in the dumpsters at will while the trash haulers can empty the dumpsters with large trucks on their own schedule. The dumpsters provide convenience to the residents but may appear unsightly initially. The dumpsters can grow more unsightly as trash billows out of an over full dumpster.

Other residential areas have large wheeled cans. The wheeled cans have sufficient capacity for the trash produced by a family of four persons in a week. The wheeled cans have a fitting upon one side that cooperates with a lifting device upon a truck. Residents usually keep the wheeled cans alongside a house or in a garage until the designated trash pickup day. Residents bear the burdens of moving the wheeled can on the designated day and any odors while having the benefit of convenient access.

In other areas, residents have trash cans. The trash cans have lids initially though the lids may disappear in time due to a variety of reasons. The residents store the trash cans in a location out of sight and downwind of the residence due to odor in summer. The residents can place trash in the cans as desired but must drag the cans to a curb for pickup. The cans have pleasing color schemes however, empty cans are prone to rolling during windy days. And, the resident must also retrieve the empty cans.

Lastly in some residential areas, residents place bags of trash at curbside. Using bags alone saves residents the expense and hassle of dealing with cans. However, bags alone usually increase the pickup frequency as fewer bags can be stored before offending the residents. Bags alone also may make an area unsightly as residents place bags out in advance of a pickup date and as animals investigate and open the bags.

The patent to Allen, U.S. Pat. No. 4,536,033 shows a tilting trash storage apparatus. The apparatus has an inclined container upon a wheeled carriage. The incline places the container near shoulder height of a person. Tilting the apparatus dumps trash from the container into another receptacle. Though useful, the apparatus does not conceal well outside of a residence. In contrast, the present invention lacks a wheeled carriage and keeps its container below waist level of a person. Decorated and with a readily opened door, the present invention can remain in view without disturbing aesthetics. The present invention requires trash bags to be pulled from the container but not dumped.

The present invention seeks to combine the advantages of convenient access of dumpsters, flexibility of cans, and ease of bags in an eye pleasing trash container.

### SUMMARY OF THE INVENTION

Generally, the present invention provides a tastefully decorated container with a hinged lid that stores bags of trash. Residents place bags in the container as desired and then the garbage men retrieve the bags on their schedule. The container can remain in one location indefinitely. The present invention has a generally rectangular box shape with a front, a left side, a right side, a rear, a lid hinged to the rear, and a bottom. The present invention has handles upon the left side and the right side for movement of the container and placement of flower boxes as desired.

There has thus been outlined, rather broadly, the more important features of the invention in order that the detailed description thereof that follows may be better understood and that the present contribution to the art may be better appreciated.

The invention may also include wheels upon the bottom, cylinders to assist in opening and closing the lid, ventilation of vapors and drainage of fluids, and a loop for anchoring the present invention. Additional features of the invention will be described hereinafter and which will form the subject matter of the claims attached.

Numerous objects, features and advantages of the present invention will be readily apparent to those of ordinary skill in the art upon a reading of the following detailed description of the presently preferred, but nonetheless illustrative, embodiment of the present invention when taken in conjunction with the accompanying drawings. Before explaining the current embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, the phraseology and terminology employed herein are for the purpose of description and should not be regarded as limiting.

One object of the present invention is to provide a new and improved temporary trash container.

Another object is to provide a temporary trash container that can be easily and efficiently manufactured and marketed to the consuming public.

Another object is to provide a temporary trash container that allows ready access by garbage men to bags within the container.

These together with other objects of the invention, along with the various features of novelty that characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there is illustrated a preferred embodiment of the invention.

### BRIEF DESCRIPTION OF THE DRAWINGS

FIG. 1 shows a perspective view of the preferred embodiment of the present invention with the lid open;

FIG. 2 shows a perspective view with the present invention open;

FIG. 3 describes a front view of the preferred embodiment of the present invention;

FIG. 4 shows a top view of the present invention with the lid closed;

FIG. 5 describes the left side view of the present invention;

FIG. 6 describes the right side view of the present invention;

FIG. 7 illustrates the rear view of the present invention;

FIG. 8 shows a front view of the present invention with the lid open;

FIG. 9 shows a top view of the present invention with the lid open; and,

FIG. 10 describes the bottom view of the present invention.

The same reference numerals refer to the same parts throughout the various figures.

### DESCRIPTION OF THE PREFERRED EMBODIMENT

The present art overcomes the prior art limitations by providing a temporary trash container of suitable size for storing trash bags and capable of decoration in front of a residence.

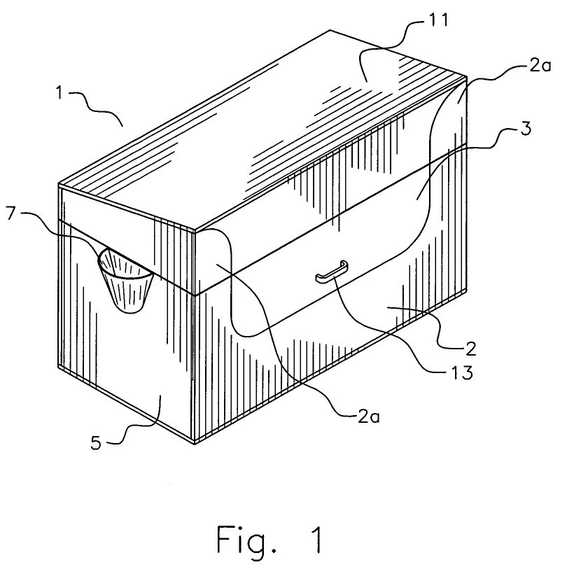

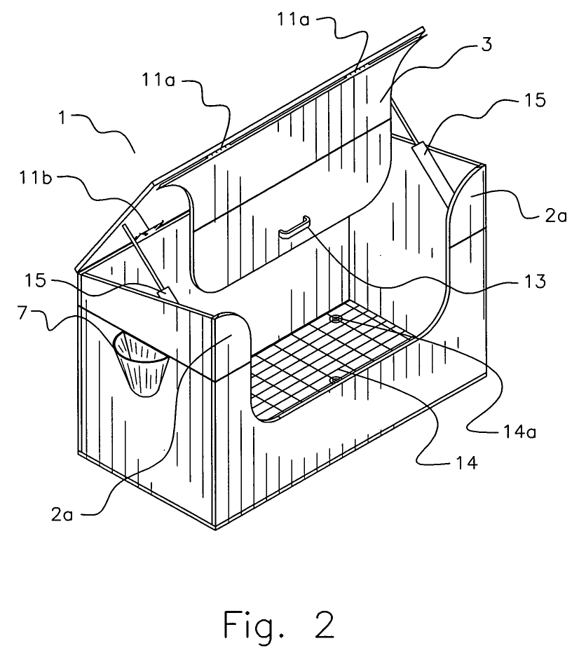

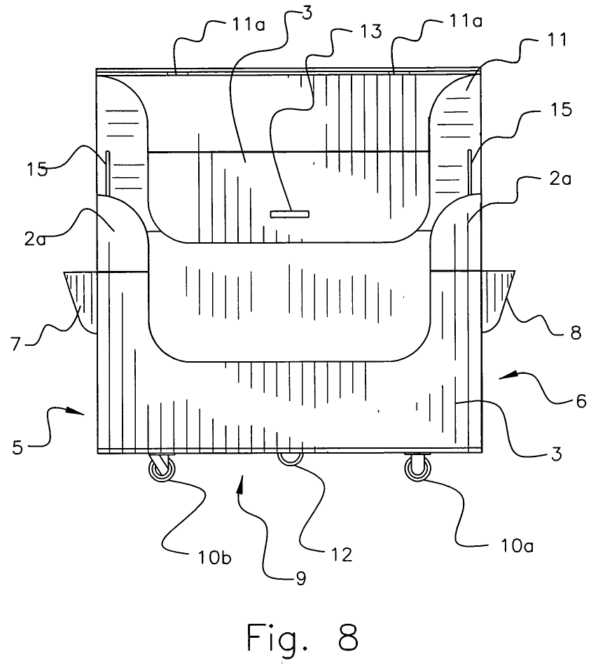

The present invention begins in FIG. 1 with a generally rectangular shaped container 1 having a lid 11 upon the top. In this view, the left side panel 5 of the container 1 is shown including the left side handle 7. The left side handle 7 is hollow and generally conical. The base of the conical shape is proximate to the lid 11 for the left side handle 7. A homeowner may place flower pots or earth within the left side handle 7 for seasonal decoration. Within the container 1, a homeowner places trash in bags and the container 1 holds at least three bags of household trash. To put in a bag and when trash pickup day arrives, the lid 11 is lifted as shown in FIG. 2. The lid 11 rotates upwards and toward the rear panel 4 of the container 1. Cylinders 15 located upon the left side panel 5 and the right side panel 6 and connecting to the underside of the lid 11 assist in opening the lid 11. The cylinders 15 can be either pneumatic or hydraulic. As the lid 11 rotates, the door 3 folds upon the underside of the lid 11, later shown in FIG. 8. The door 3 when folded away provides ready access to the interior of the container 1.

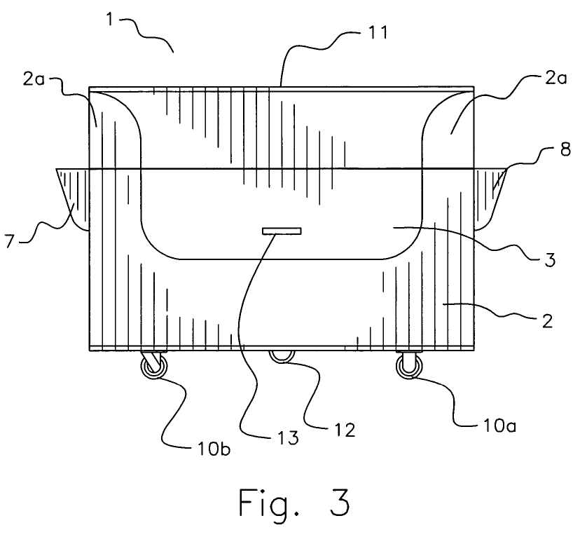

Looking at the present invention 1 more closely, the invention appears in FIG. 3 and has a generally rectangular shaped container 1 having a lid 11 upon the top. The container 1 has a rectangular front panel 2 having a longitudinal axis generally horizontal. Within the front panel 2, a door 3 provides access to trash bags stored within the present invention 1. The door 3 is narrower than the length of the container 1 and shallower than the height of the container 1. The door 3 though does hingedly attach to one longitudinal side of the lid 11. In the preferred embodiment, the door 3 has two second hinges 11a connected to the lid 11. The door 3 flares in width as it approaches the lid 11, forming shoulders 2a upon both ends of the front panel 2. The door 3 has a pull 13 centered and proximate to the bottom. The pull 13 allows a resident or a garbage man to open the present invention 1. Extending rearward from the front panel 2, the present invention 1 has a left side panel 5 and a right side panel 6 denoted by a handle 7, 8 upon each side. In front view, the handles 7, 8 have a generally conical shape with the surface extending upward and away from the respective sides. The handles 7, 8 have sufficient width to support a flower box yet permit a person to grasp the handle 7, 8 by hand.

Viewing the front panel 2 of the container 1, the door 3 and shoulders 2a have a band of decoration suitable to mimic flower boxes. The left handle 7 and the right handle 8 permit placement of flower pots or earth within them. The decorative band is located above the level of the left handle 7 and the right handle 8.

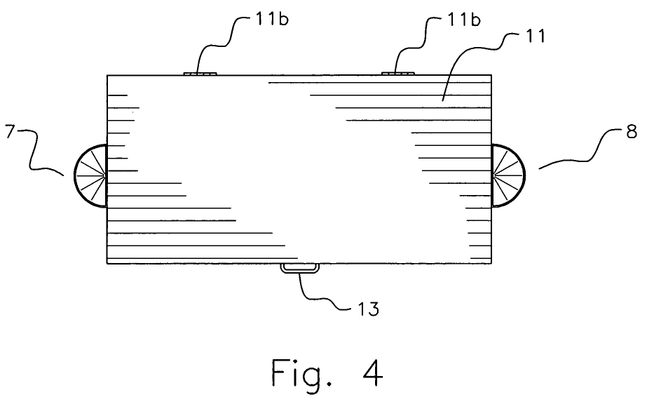

FIG. 4 then shows the top of the present invention 1, primarily the lid 11. The lid 11 has a generally rectangular shape that covers the footprint of the present invention 1 and seals in trash bags placed into the present invention 1. The lid 11 connects to the rear panel 4 of the container 1 with two first hinges 11b. The first hinges 11b permit the lid 11 to open upwards and rear panel 4 wards for ready access to the contents of the container 1. To the left of the front panel 2, the left handle 7 extends outwards. The left handle 7 has a generally round base of a conical shape for supporting a flower pot and permitting a person to grasp. Opposite the left handle 7, the right handle 8 extends outwards from the right side panel 6. The right handle 8 also has a generally round base of a conical shape that supports a flower box and permits a person to grasp the present invention 1. The left handle 7 and the right handle 8 are hollow and permit placement of a flower pot or earth within the left handle 7 and the right handle 8. A homeowner may decorate the handles as the seasons inspire.

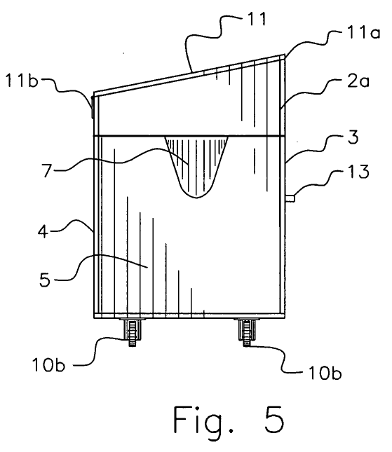

Turning to the left side panel 5, FIG. 5 shows the left handle 7 generally centered upon the left side panel 5. The left handle 7 has a frusto-conical shape with the base proximate toward the lid 11 and the rounded point towards the bottom panel 9 and the left side panel 5. The left side panel 5 has a generally trapezoidal shape with the higher base located towards the front panel 2 and the door 3. The trapezoidal shape allows precipitation to drain off the present invention 1 towards the rear panel 4 and away from those opening the container 1. The lid 11 extends from the higher front panel 2 towards the rear panel 4. The second hinges 11a connect the door 3 to the lid 11 at the front panel 2 and the first hinges 11b connect the lid 11 to the rear panel 4 of the invention. The decorative band continues on the left side panel 5 as it encircles the invention. The decorative band has a constant bottom elevation around the invention. Beneath the left side panel 5, the bottom has two moveable wheels 10b upon brackets, as in a Simpson wheel. The wheels 10b proximate to the left side panel 5 turn in the direction of movement of the container 1.

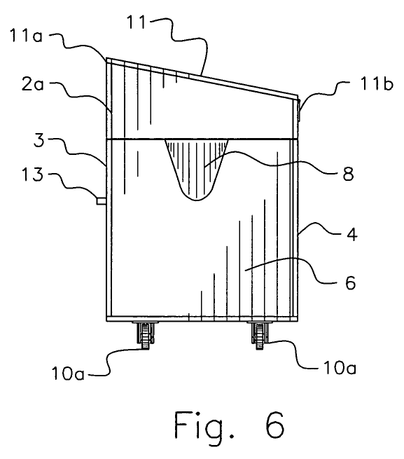

Turning to the right side panel 6, FIG. 6 shows nearly the reverse of FIG. 5. The right handle 8 is generally centered upon the right side panel 6 and has a frusto-conical shape with the base proximate toward the lid 11 and the rounded point towards the bottom panel 9 and the right side panel 6, symmetric to the left side panel 5. The right side panel 6 has a generally trapezoidal shape with the lower base located towards the rear panel 4 and away from the door 3. The trapezoidal shape allows precipitation to drain off the present invention 1 towards the rear panel 4 and away from people opening the container 1. The second hinges 11a connect the door 3 to the lid 11 at the front panel 2 and the first hinges 11b connect the lid 11 to the rear panel 4 of the invention. The decorative band continues on the right side panel 6 as it encircles the invention at a constant bottom elevation. Beneath the right side panel 6, the bottom has two wheels 10a upon brackets. Alternatively, the wheels 10a can be upon an axle. The wheels 10a proximate to the right side panel 6 are generally fixed in position.

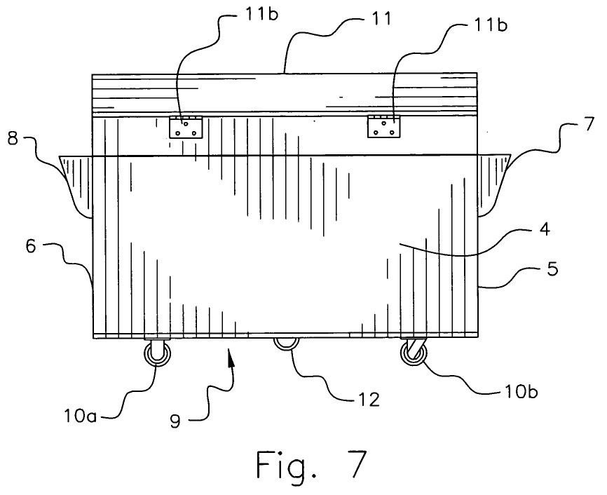

Then FIG. 7 shows the rear panel 4 of the present invention 1. The rear panel 4 has the lowest elevation and a generally rectangular shape. The rear panel 4 has one or more first hinges 11b, two in the preferred embodiment, to connect the lid 11. The first hinges 11b are located upon the top edge of the rear panel 4. Beneath the rear panel 4, the container 1 has a loop 12 generally located towards the front panel 2. The loop 12 provides an anchoring point for the container 1 using either a stake or rope. Away from the loop 12 towards the left side panel 5 of the invention, the bottom has a moveable wheel. As before, the moveable wheels 10b are Simpson type, turning in the direction of movement thus steering the container 1. Opposite the moveable wheels 10b, the preferred embodiment has wheels 10a generally fixed with the plane of the wheels 10a located parallel to the longitudinal axis of the container 1. Upwards from the bottom on the left side panel 5, the container 1 has the left handle 7 that supports flower pots or earth. On the opposite right side panel 6, the container 1 has the right handle 8 symmetric to the left handle 7 and that supports flower pots or other decoration.

Eventually, trash pick up day arrives and FIG. 8 shows the container 1 with the lid 11 fully opened. Viewing the front panel 2 of the container 1, a person grasps the pull 13 and moves the door 3 slightly forward and the lid 11 upward. Raising the lid 11 also rotates the lid 11 towards the rear panel 4 of the container 1. In rotating the lid 11, the person also pushes the door 3 towards the lid 11. The door 3 folds upon the underside of the lid 11 via the second hinges 11a and the lid 11 opens coplanar with the rear panel 4 of the container 1 via the first hinges 11b. With the door 3 folded upon the lid 11 and the lid 11 open, a garbage man reaches into the container 1 to remove bags of trash. The door 3 folded upon the lid 11 provides full access to the interior of the container 1.

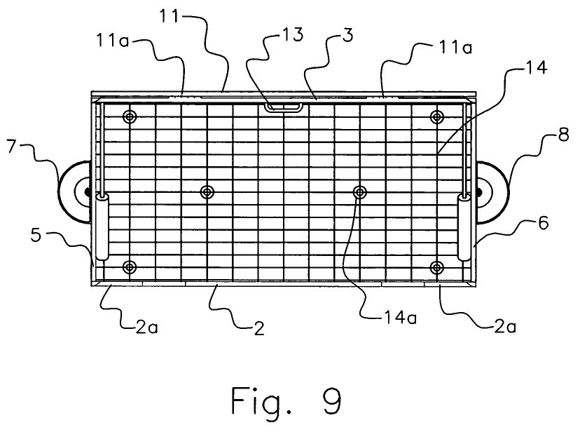

Viewing the container 1 with the lid 11 open, the bottom appears in FIG. 9. The empty container 1 shows a bottom having a plurality of holes 14a. The holes 14a penetrate through the thickness of the bottom. The holes 14a permit drainage of fluids and ventilation of odors. Above the holes 14a, a mesh or grid 14 raises the bags of trash above the holes 14a to ease drainage and ventilation. In the preferred embodiment the grid 14 is a plastic material, resistant to corrosion.

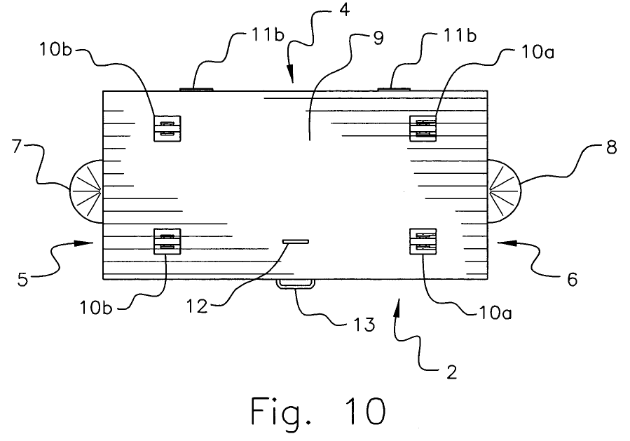

Beneath the front panel 2, the present invention 1 has a bottom shown in FIG. 10. The bottom is perpendicular to the front panel 2, door 3, left side panel 5, and right side panel 6 and opposite the lid 11. The bottom has a loop 12 generally centered and towards the front panel 2. The loop 12 provides a location for anchoring the present invention 1 against wind and theft. In the preferred embodiment, the loop 12 is steel and secures to a stake or rope. Towards the right side panel 6, the bottom has two wheels 10a located within the footprint of the present invention 1. The wheels 10a are generally mutually parallel and supported upon brackets. Towards the left side panel 5, the bottom has two moveable wheels 10b located within the footprint of the present invention 1. The brackets of the moveable wheels 10b permit rotation about an axis parallel to the diameter of the moveable wheels 10b. The moveable wheels 10b allow a resident to steer the present invention 1 during motion.

From the aforementioned description, a temporary trash container has been described. The temporary trash container is uniquely capable of holding bags of trash concealed yet permitting ready removal of the bags when required. The temporary trash container also permits a homeowner to place flower pots within the left handle and the right handle and to decorate the lid as the seasons may inspire. The temporary trash container and its various components may be manufactured from many materials including but not limited to steel, ferrous and non-ferrous metals, their alloys, polymers, high density polyethylene, polyvinyl chloride, nylon, and composites.

As such, those skilled in the art will appreciate that the conception, upon which this disclosure is based, may readily be utilized as a basis for the designing of other structures, methods and systems for carrying out the several purposes of the present invention. Therefore, the claims include such equivalent constructions insofar as they do not depart from the spirit and the scope of the present invention.

1. A container, tastefully decorated, to temporarily conceal bags of trash in a generally residential setting, comprising:
a front panel generally upright;
a door, detachable from said front panel;
a rear panel mutually parallel and opposite said front generally upright and lower in elevation than said front;
a left side panel upright, spanning between said front panel and said rear panel;
a right side panel upright, mutually parallel and opposite said left side;
a left handle generally centered upon said left side;
a right handle generally centered upon said right side;
a bottom panel generally oriented flat and joining to said front panel, said rear panel, said left side, and said right side upon the perimeter edges of said bottom, said bottom panel having two or more wheels; and,
a lid opposite said bottom panel; connecting to said door by one or more second hinges and connecting to said rear panel by one or more first hinges;
whereby said container is located at a convenient place, said lid and said door are raised, trash bags are placed into said container as filled, and at a regular interval the trash bags are removed from said container for disposal.

2. The container of claim 1 further comprising:
said bottom panel having two spaced apart mutually parallel wheels fixed in direction, two spaced apart movable wheels that turn into the direction of motion, and a loop descending from said bottom generally proximate said front and permitting anchoring of said container.

3. The container of claim 1 further comprising:
said door having a pull extending outwards from said door generally centered and towards said bottom panel, and a width narrower than said front panel but flaring outwards proximate to said lid; and,
said front panel having symmetric shoulders flanking said door, said shoulders rounding and narrowing in width as said door flares outward in width.

4. The container of claim 1 further comprising:
said left handle having a frusto-conical shape joined to said left side panel forming a hollow shape; and,
said right handle having a frusto-conical shape joined to said right side panel forming a hollow shape;
whereby said left handle and said right handle permit insertion of one or more flower pots.

5. The container of claim 4 wherein said door, said front panel, said left side panel, said rear panel, and said right side panel have a decorative band located proximate to said lid and in cooperation with said left handle and said right handle.

6. The container of claim 1 further comprising:
a grid installing within said container upon said bottom panel, having a generally rectangular shape; and,
said bottom panel having a plurality of holes.

7. The container of claim 1 further comprising:
one or more cylinders extending from said lid to said left side and said right side and assisting in raising said lid from said front panel.

8. The container of claim 1 further comprising:
said front panel, said rear panel, said lid, said bottom panel having a rectangular shape;
said door having rounded corners opposite said lid; and,
said left side panel and said right side panel having a trapezoidal shape.
